(19) United States
(12) Patent Application Publication
(10) Pub. No.: US 2024/0179002 A1
(43) Pub. Date: May 30, 2024

(54) Web Access Management System

(71) Applicant: Scalefast Inc., Wilmington, DE (US)

(72) Inventors: Frédéric BOCQUET, Wilmington, DE (US); Axel AMIGO ARNOLD, Wilmington, DE (US); Andrés TÉLLEZ SUÁREZ, Wilmington, DE (US)

(73) Assignee: Scalefast Inc., Wilmington, DE (US)

(21) Appl. No.: 18/170,397

(22) Filed: Feb. 16, 2023

(30) Foreign Application Priority Data
Nov. 25, 2022 (FR) 2212341

(51) Int. Cl. H04L 9/32; G06F 21/62

(52) U.S. Cl. CPC H04L 9/3213; G06F 21/6218

(57) ABSTRACT

A web access management system comprising a memory storing an access data structure with position identifiers and access tokens, an analyser measuring the load of a web server, and periodically determining a queue activation condition, and a queue access release condition. A distributor receiving a request to access a web page and, when the queue activation condition is positive, to test if this request has a valid access token. If valid, access granted and, if not valid, to send back to the client browser a waiting web page comprising a position identifier specific to the client browser and indicating its position in the queue, and to store this position identifier in the access data structure without matching it with an access token. The analyser extracts position identifiers that indicate are the oldest and generate for each position identifier a valid access token and store said.

### CROSS REFERENCE TO RELATED APPLICATION

The present application claims priority of French Patent Application No. 2212341 filed Nov. 25, 2022. The entire contents of which are hereby incorporated by reference.

### FIELD OF INVENTION

The invention relates to the field of access management to websites, and in particular queue management.

### BACKGROUND

During certain events, websites may be subjected to tens of thousands of access requests per second, or even hundreds of thousands of access requests per second.

Obviously, it is not possible or optimal to size the service architecture of a website to be able to support such a load constantly. At the same time, if nothing is done, this type of situation has the same effect as an attack of the Denial of Service (“DoS”) type.

This phenomenon is heightened further as the contents of websites are now highly personalised and their generation results in a computational load on the web server side that is significant. In response, queue mechanisms have been implemented. These mechanisms are based on static parameters on the server side that determine a fixed number of clients to be connected to the server, the others being relegated in a waiting lock. The mechanism used is that of a waiting room: each user has a ticket, and they are admitted depending on the number of tickets in use and of their position in the queue.

These mechanisms are not very effective. Indeed, they are based on an assessment of the future load and on the suitable configuration of the web server. Yet, even if a load day or another period is correctly identified, the load itself is dynamic on that date. Thus, during a launch of a product, there is a huge peak at the launch time, then the demand progressively reduces. Consequently, the queue is generally undersized in relation to the requirement upon launch, then subsequently oversized. In addition, this is the favourable case where the load has been correctly anticipated.

### SUMMARY

The invention improves the situation. To this end, it proposes a web access management system comprising a memory arranged to store an access data structure the inputs of which comprise position identifiers and access tokens, an analyser arranged to measure the load of a web server the access of which is managed by the access management system, and to periodically determine a queue activation condition, and a queue access release condition with a corresponding number of accesses, and a distributor arranged to receive a request to access a web page of a client browser, and, when the queue activation condition is positive, to test if this request to access a web page has a valid access token, to make it possible to access the web page concerned if the access token is valid, and, if the access token is not valid, to return to the client browser a waiting web page comprising a position identifier specific to the client browser and indicating its position in the queue, and to store this position identifier in the access data structure without matching it with an access token.

The analyser is arranged, in the event of a queue access release condition, to extract from the access data structure position identifiers such that the positions in the queue that they indicate are the oldest and the number of which is equal to the corresponding number of accesses of the queue access release condition, to generate for each position identifier a valid access token, and to store each valid access token matching the position identifier for which it was generated in the access data structure, the waiting web page comprising a JavaScript code inducing a periodic page reloading as well as a position identifier request in the access data structure, and in the event of receipt in response of a valid access token, to trigger a new request to access a web page with the valid access token.

This device is particularly advantageous because it makes it possible to perform a dynamic management of the queue, and therefore to ideally size the queue depending on the load of the server. The system, thanks to the analyser, adapts in real time the size of the queue and its management depending on the needs of the web server. This mechanism even makes it possible to manage server failures, including during “normal” periods where peaks are not expected. Thus, rather than make the web server go down, a waiting page is displayed.

According to various embodiments, the invention may have one or more of the following features the access data structure comprises a stack of position identifiers wherein the distributor stores the position identifiers,—the access data structure comprises an access stack and wherein the analyser is arranged to generate token generation data based on the number of accesses corresponding to a queue access release condition and to store them in the valid access stack, the access data structure comprises a valid access storage wherein the analyser is arranged to generate a valid access token for each input of the access stack, to unstack the stack of position identifiers so as to extract position identifiers such that the positions in the queue that they indicate are the oldest, and to store a pair comprising a position identifier and a valid access token in the valid access stack.

The invention also relates to a web access management method comprising the following operations: a) storing an access data structure the inputs of which comprise position identifiers and access tokens, b) measuring the load of a web server the access of which is managed by the access management system, and periodically determining a queue activation condition, and a queue access release condition with a corresponding number of accesses, c) when operation b) determines a queue access release condition, extracting from the access data structure position identifiers such that the positions in the queue that they indicate are the oldest and the number of which is equal to the corresponding number of accesses of the queue access release condition, and generating for each position identifier a valid access token, and storing each valid access token matching the position identifier for which it was generated in the access data structure, d) on receipt of a request to access a web page of a client browser, and, when the queue activation condition is positive, testing if this request to access a web page has a valid access token, making it possible to access the web page concerned if the access token is valid, and, if the access token is not valid, returning to the client browser a waiting web page comprising a position identifier specific to the client browser and indicating its position in the queue, and storing this position identifier in the access data structure without matching it with an access token, the waiting web page comprising a JavaScript code inducing a periodic page reloading as well as a position identifier request in the access data structure, and, in the event of receipt in response of a valid access token, repeating operation b) with the valid access token.

According to various embodiments, the method may have one or more of the following features the access data structure comprises a stack of position identifiers, and operation d) comprises storing the position identifiers in said stack of position identifiers, the access data structure comprises an access stack and operation c) comprises generating token generation data based on the number of accesses corresponding to a queue access release condition and storing them in the valid access stack,—the access data structure comprises a valid access storage and operation c) comprises generating a valid access token for each input of the access stack, unstacking the stack of position identifiers so as to extract position identifiers such that the positions in the queue that they indicate are the oldest, and storing a pair comprising a position identifier and a valid access token in the valid access stack.

The invention also relates to a computer program implemented by computer comprising instructions for executing the method according to the invention, a data storage medium wherein such a computer program is saved and a computer system comprising a processor coupled to a memory, the memory having saved such a computer program.

### BRIEF DESCRIPTION OF THE DRAWINGS

Other features and advantages of the invention will become more apparent upon reading the following description, taken by way of illustrative and non-limiting examples, taken from drawings wherein:

FIG. 1 shows a schematic diagram of a web access management system according to the invention.

FIG. 2 shows an example of operation loop of the web access management system of FIG. 1.

FIG. 3 shows an example of implementation of a function of FIG. 2.

FIG. 4 shows an example of operation loop of the analyser of FIG. 1.

### DETAILED DESCRIPTION

The drawings and the following description mainly contain elements of certain character. Therefore, not only may they be used to better understand the present invention, but also to help to define it, if necessary.

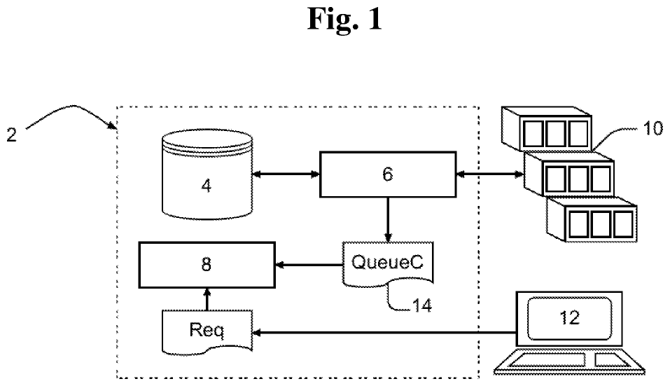

FIG. 1 shows a schematic diagram of a web access management system 2 according to the invention. The web access management system 2 comprises a memory 4, an analyser 6 and a distributor 8. The web access management system 2 receives requests to access a web server 10, in particular web pages, of one or more devices 12 that are connected to the Internet.

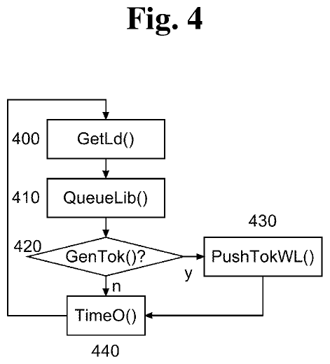

In the example described here, the analyser 6 monitors the web server 10 in order to measure parameters that make it possible to determine the number of requests to access the web content that it is capable of managing over the short term. The operation of the analyser 6 will be explained below with reference to FIG. 4.

The memory 4 receives a data structure that makes it possible for the web access management system 2 to implement a dynamic queue that depends on parameters measured by the analyser 6. Thus, the analyser 6 determines on the one hand a queue condition 14 which indicates if the web access management system 2 does or does not implement the queue. When the queue management condition 14 is positive, the analyser 6 may issue a queue release condition, as well as the number of devices the requests of which may be served.

The memory 4 may be any type of specific data storage for receiving digital data: hard drive, flash memory hard drive, flash memory in any form, random access memory, magnetic disk, storage distributed locally or in the cloud, etc.

In the example described here, the memory 4 receives all of the data that relate to the device 2, that is to say the programs and software instantiating the analyser 6 and the distributor 8, their parameters, the request data received as input, the intermediate values such as the session cookies, the access tokens, the data stored in the buffer memory, as well as the output data. The data computed by the device may be stored on any type of memory similar to the memory 4, or on the latter. These data may be erased after the device has carried out its tasks or kept.

The analyser 6 and the distributor 8 directly or indirectly access the memory 4. They may be produced in the form of a suitable computer code executed on one or more processors. By processors, it must be understood any processor adapted to the calculations described below. Such a processor may be produced in any known way, in the form of a microprocessor for personal computer, laptop, tablet or smartphone, of an FPGA or SoC type dedicated chip, of a computing resource on a grid or in the cloud, of a cluster of graphic processing units (GPUs), of a microcontroller, or of any other specific form to provide the computing power necessary for the embodiment described below. One or more of these elements may also be produced in the form of specialist electronic circuits such as an ASIC. A combination of processor and of electronic circuits may also be envisaged. Processors dedicated to machine learning may also be envisaged.

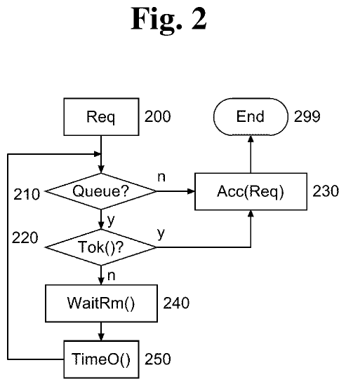

FIG. 2 shows an example of an operation loop of the web access management system 2 according to the invention when it receives a request from a device 12.

Thus, in an operation 200, the web access management system 2 receives a request to access a website managed by the web server 10. This request is received by the distributor 8, the function of which is to verify if it is possible to give access to the web server 10 to implement the request of the device 12.

This is firstly performed in an operation 210 when which the queue condition 14 is or is not activated. If this is the case, then the distributor 8 tests in an operation 220 if the request has a valid session access token. In the example described here, the access tokens are of the JSON Web Token (JWT) type. JWT are defined in the RFC 7519 and make the secure exchange of tokens possible between various parties, the security being implemented by means of an HMAC or RSA algorithm that makes it possible to verify the authenticity and the integrity of the data of the tokens. JWT are particularly useful because they can be easily integrated into the structures of modern web servers that are digitised by storage and computing resource suppliers, such as Amazon Web Services (registered trademark).

Although JWT are described here, the person skilled in the art will know how to recognise that other types of tokens may be used, so that in the following, the notion of “access token” in its broadest generality will be used and within the scope of the invention.

If the request has a valid token or if the queue is not activated, then the distributor 8 grants the access to the web server 10 by executing an Acc( ) function in an operation 230, and the loop finishes in an operation 299, as the device 12 has had access to the web server 10.

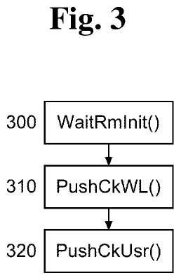

If the JWT is not valid, or if the request does not comprise JWT, then the operation 220 returns a negative result, and the device 12 is redirected to a waiting page in an operation 240, and a WaitRm( ) function is executed. FIG. 3 shows an example of implementation of the WaitRm( ) function.

As can be seen in this figure, the WaitRm( ) function starts by executing a WaitRmInit( ) function in an operation 300. The WaitRmInit( ) function has two functions: redirecting the device 12 to the waiting web page, and generating the session cookie that will be used to grant the access to the web server 10.

Once the session cookie has been generated, a PushCkWL( ) function is executed in an operation 310. The PushCkWL( ) function recovers the cookie generated in the operation 300, and introduces it into the access data structure stored in the memory 4. First of all, this cookie will be stored in a stack of position identifiers.

After the execution of the operation 310, or at the same time as this, the cookie is pushed towards the device 12 in an operation 320 wherein a PushCkUst( ) function is executed.

Advantageously, a verification may be carried out that the operation 310 and the operation 320 have both been successfully completed in order to guarantee that the cookie submitted to the device 12 will make it possible for it to indeed access the web server 10.

As can be seen in FIG. 4, the stack of position identifiers is unstacked as and when the analyser 6 determines that new accesses to the web server 10 may be opened, which makes it possible to generate a JWT that is associated with a cookie in a valid access stack that also forms part of the data structure. At the same time, the device 12 regularly accesses the valid access stack to recover its JWT once the latter has been generated and to be able to present it to the distributor 8.

Once the operation 240 has been completed, the device 12 executes a TimeO( ) function in an operation 250, which makes it wait for a selected amount of time before resuming the loop with the operation 210.

FIG. 4 explains the operation of the analyser 6 to determine the queue condition, the queue access release condition and the execution of the corresponding actions to make it possible for the devices 12 to obtain the JSON making it possible for them to access the web server 10.

Thus, in an operation 400, the analyser 6 executes a GetLd( ) function. The GetLd( ) function accesses the web server 10 and recovers a set of measurements that make it possible to determine a current load state of the server, as well as elements that make it possible to perform a short-term forecast of the load of the web server 10 in order to adapt the sizing of the queue and the possible release therefrom.

The GetLd( ) function is in the example described here arranged to recover one or more of the following load measurements: average system load, memory use amount, number of active web processes (for example number of PHP-FPM (FastCGI Process Manager)), or also the number of database (MySQL or other database) connections used. These measurements may of course be standardised, presented in the form of vectors or tables in order to have a more accurate view of the load of the multi-server architecture, etc.

Once the measurements have been recovered in the operation 400, the analyser 6 executes a QueueLib( ) function in an operation 410. This function firstly determines the queue condition 14, that is to say if the load of the web server 10 requires the activation of the queue. Subsequently, if the queue condition 14 is still positive, the QueueLib( ) function determines a queue access release condition, that is to say the number of accesses that may be released to access the web server 10. In practice, this number of accesses results in a number of JWT to be generated.

In order to decide on the queue condition, the QueueLib( ) function may operate by thresholding the value of one or more measurements obtained by the GetLd( ) function. For example, each measurement may be associated a degree of criticality depending on its value.

Thus, for a standardised average system load measurement, a degree of criticality over 4 values may be defined as follows: 0 if value <60%; 1 if 60%≤value <70%; 2 if 70%≤value<90%, and 3 if 90%≤value. Similarly, for the standardised memory use amount measurement, a degree of criticality over 4 values may be defined as follows: 0 if value<70%; 1 if 70%≤value<80%; 2 if 80%≤value<90%, and 3 if 90%≤value. Still as an example, for an active web process number measurement, a degree of criticality over 4 values may be defined as follows: 0 if value<600; 1 if 600≤value<1,000; 2 if 1000≤value<1,500, and 3 if 1,500≤value. Finally, still by way of example, for a database connection number measurement, a degree of criticality over 4 values may be defined as follows: 0 if value<50; 1 if 50≤value<150; 2 if 150≤value<200, and 3 if 200≤value.

The QueueLib( ) function may for example be arranged to determine a positive queue condition if one or more of the criticality indices is greater than or equal to 1. If the index is equal to 0, then the queue is closed and the access to the server is opened. It goes without saying that many variants may be envisaged, relating to the measurements, and to the processing of their values to determine the queue condition, which may combine one or more measurements, comprise a time change component, etc. Of course, the criticality indices above are given by way of example and their number, value and ranges and/or determination formula may also vary.

Similarly, the queue release condition may depend on the criticality index of one or more measurements. For example, the queue release condition may be negative if one or more of the indices is equal to 3. As for the queue condition, it goes without saying that many variants may be envisaged, relating to the measurements, and to the processing of their values to determine the queue condition, which may combine one or more measurements, comprise a time change component, etc.

A GenTok( ) function is then executed in an operation 420 and determines if JWT must be issued in view of the queue access release condition. The GenTok( ) function may determine the number of accesses of the queue access release condition on the basis of the criticality index of one or more measurements. For example, the number of accesses may be initialised at a starting value, then, every time that the queue access release condition is evaluated, the number of accesses is increased if one or more of the indices (or their average) is equal to 1, reduced if one or more of the indices (or their average) is equal to 2, and brought to 0 if one or more of the indices (or their average) is equal to 3. Of course, other rules may be retained. Still as a variant, the GenTok( ) function may absolutely determine the number of accesses, on the basis of the measurements and/or of other elements.

If this test is positive, that is to say if the number of accesses is not zero, then a number of JWT corresponding to the number of accesses of the queue access release condition is generated, and these tokens are introduced into the valid access stack by a PushTokWL( ) function in an operation 430. More specifically, this function unstacks the stack of position identifiers by order of age in the queue and recovers a number of cookies that corresponds to the number of accesses of the queue access release condition. Thus, JWT/cookie pairs are created and introduced into the valid access stack.

Once the operation 430 has finished, or when the queue access release condition indicates that no token must be generated, the TimeO( ) function is executed in an operation 440 and the analyser 6 waits a selected duration before relaunching its operation loop with the operation 400. The duration of the operation 440 may of course be different than that of the operation 250. Furthermore, it may also be variable, in order to ensure that the entire loop of the analyser 6 has a selected duration.

As mentioned above, at the same time, the waiting page has a JavaScript code that periodically generates an access to the valid access stack to determine if a valid access JWT has been generated for its cookie, as well as the reloading of the operation 210. When a JWT/cookie pair has been loaded into the valid access stack of the data structure, the JWT is transmitted to the corresponding device 12 as of its next access, and the pair is removed from the valid access stack.

Once the device 12 has recovered its valid access token, it is authenticated in the operation 220 and the access is granted.

The web access management system 2 described here is particularly efficient because it may be integrally implemented thanks to structureless remote code functions such as Amazon Lambda functions. In addition, the use of the stack of position identifiers and of the valid access stack makes it possible to generate a reliable process wherein the analyser 6 controls little by little the access to the web server 10, thanks to measurements that make it possible to adapt as best as possible the size of the queue and its dynamic.

1. A web access management system comprising:
a memory arranged to store a data access structure the inputs of which comprise position identifiers and access tokens;
an analyser arranged to measure the load of a web server the access to which is managed by the access management system, and to periodically determine a queue activation condition, and a queue access release condition with a corresponding number of accesses; and
a distributor arranged to receive a request to access a web page from a client browser, and, when the queue activation condition is positive, to test if this request to access a web page has a valid access token, to make it possible to access the web page concerned if the access token is valid, and, if the access token is not valid, to return to the client browser a waiting web page comprising a position identifier specific to the client browser and indicating its position in the queue, and to store this position identifier in the access data structure without matching it with an access token,
the analyser being arranged, in the event of a queue access release condition, to extract from the access data structure position identifiers such that the positions in the queue that they indicate are the oldest and the number of which is equal to the corresponding number of accesses of the queue access release condition, to generate for each position identifier a valid access token, and to store each valid access token matching the position identifier for which it was generated in the access data structure, and
the waiting page web comprising a JavaScript code inducing a periodic page reloading as well as a position identifier request in the access data structure, and, in the event of receipt in response of a valid access token, to trigger a new request to access a web page with the valid access token.

2. The web access management system according to claim 1, wherein the access data structure comprises a stack of position identifiers wherein the distributor stores the position identifiers.

3. The web access management system according to claim 1, wherein the access data structure comprises an access stack and wherein the analyser is arranged to generate token generation data based on the number of accesses corresponding to a queue access release condition and to store them in the valid access stack.

4. The web access management system according to claim 2, wherein the access data structure comprises a valid access storage and wherein the analyser is arranged to generate a valid access token for each input of the access stack, to unstack the stack of position identifiers so as to extract position identifiers such that the positions in the queue that they indicate are the oldest, and to store a pair comprising a position identifier and a valid access token in the valid access stack.

5. A web access management method comprising the following operations:
a) storing an access data structure the inputs of which comprise position identifiers and access tokens;
b) measuring the load of a web server the access of which is managed by the access management system, and periodically determining a queue activation condition, and a queue access release condition with a corresponding number of accesses;
c) when operation b) determines a queue access release condition, extracting from the access data structure position identifiers such that the positions in the queue that they indicate are the oldest and the number of which is equal to the corresponding number of accesses of the queue access release condition, and generating for each position identifier a valid access token, and storing each valid access token matching the position identifier for which it was generated in the access data structure;
d) on receipt of a request to access a web page of a client browser, and, when the queue activation condition is positive, testing if this request to access a web page has a valid access token, making it possible to access the web page concerned if the access token is valid, and, if the access token is not valid, returning to the client browser a waiting web page comprising a position identifier specific to the client browser and indicating its position in the queue, and storing this position identifier in the access data structure without matching it with an access token, the waiting web page comprising a JavaScript code inducing a periodic page reloading as well as a position identifier request in the access data structure, and, in the event of receipt in response of a valid access token, repeating operation b) with the valid access token.

6. The method according to claim 5, wherein the access data structure comprises a stack of position identifiers, and wherein operation d) comprises storing the position identifiers in said stack of position identifiers.

7. The method according to claim 5, wherein the access data structure comprises an access stack and wherein operation c) comprises generating token generation data based on the number of accesses corresponding to a queue access release condition and storing them in the valid access stack.

8. Method according to claim 6, wherein the access data structure comprises a valid access storage and wherein operation c) comprises generating a valid access token for each input of the access stack, unstacking the stack of position identifiers so as to extract position identifiers such that the positions in the queue that they indicate are the oldest, and storing a pair comprising a position identifier and a valid access token in the valid access stack.

9. Computer program comprising instructions for executing the method according to claim 5.

10. Data storage medium wherein the computer program is saved according to claim 9.
